(19) United States
(12) Patent Application Publication
(10) Pub. No.: US 2010/0013132 A1
(43) Pub. Date: Jan. 21, 2010

(54) ELASTIC BEARING BUSH

(75) Inventor: Arndt Graeve, Koblenz (DE)

Correspondence Address: LERNER GREENBERG STEMER LLP, P O BOX 2480, HOLLYWOOD, FL, 33022-2480, US

(73) Assignee: TRELLEBORG AUTOMOTIVE GERMANY GMBH, Hohr-Grenzhausen (DE)

(21) Appl. No.: 12/569,095

(22) Filed: Sep. 29, 2009

Related U.S. Application Data
(63) Continuation of application No. PCT/EP2008/053117, filed on Mar. 14, 2008.

(30) Foreign Application Priority Data
Mar. 29, 2007 (DE) 10 2007 015 239.8

(51) Int. Cl. F16F 1/387

(52) U.S. Cl. 267/281

(57) ABSTRACT

An elastic bearing bush, particularly for use in a chassis of a motor vehicle, has a housing, a core disposed inside the housing, and an elastomer body connecting the housing to the core. The bearing bush has different damping properties in a first spatial direction and a second spatial direction. The bearing bush has a substantially rectangular base surface. The spring and damping properties are determined in the first spatial direction by at least one air spring element and in the second spatial direction by at least one elastomer spring.

### CROSS-REFERENCE TO RELATED APPLICATION

This is a continuing application, under 35 U.S.C. §120, of copending international application No. PCT/EP2008/053117, filed Mar. 14, 2008, which designated the United States; this application also claims the priority, under 35 U.S.C. §119, of German patent application No. DE 10 2007 015 239.8, filed Mar. 29, 2007; the prior applications are herewith incorporated by reference in their entirety.

### BACKGROUND OF THE INVENTION

### Field of the Invention

The present invention relates to an elastic bearing bush having an essentially rectangular base, in particular for use in a chassis of a motor vehicle, containing a housing, a core disposed inside the housing, and an elastomer body connecting the housing to the core. The bearing bush has different springing and damping properties in a first spatial direction and a second spatial direction.

Such bearing bushes are often used as chassis bushes. For such bearing bushes it is often necessary, that they have different springing and damping properties in different spatial directions. Their use in a chassis makes it necessary, for example, that they have very high stiffness in the vehicle transverse direction, while a substantially smaller stiffness is sufficient in the vehicle longitudinal direction.

To achieve this, in European patent EP 1 056 962 B1 (corresponding to U.S. Pat. No. 6,378,853), an essentially cylindrical rubber bearing is suggested, wherein the elastomer body varies in its thickness, or has recesses, in the circumferential direction. An inner portion, by which the elastomer body is supported, has its largest radial extension in the area of the recesses. Further, the rubber bearing has channels in its edge area, which allow air to be vented or a liquid damping to be passed from a recess to a respective opposing recess.

German patent DE 1 159 704 B discloses an elastic bush, wherein a core is supported in a housing via two elastomer bodies abutting against each other. The elastomer bodies have slots which are to enable an axial sliding moveability.

Published, non-prosecuted German patent application DE 102 00 764 A1 discloses an air spring bearing including a housing with a square basic shape. A core is supported at the housing via an elastomer body having webs. The elastomer body forms four so-called dynamic chambers. The chambers are filled with air or nitrogen, for example. The air can escape from the chambers via a throttle opening.

### SUMMARY OF THE INVENTION

It is accordingly an object of the invention to provide an elastic bearing bush which overcomes the above-mentioned disadvantages of the prior art devices of this general type, which has damping properties which are easily adjustable and which can be cheaply and easily manufactured.

With the foregoing and other objects in view there is provided, in accordance with the invention an elastic bearing bush. The bearing bush contains a housing, a core disposed within the housing, at least one air spring element, at least one elastomer spring, and an elastomer body connecting the housing to the core. The bearing bush has a generally rectangular base. The bearing bush has different springing and damping properties in a first spatial direction and a second spatial direction. The springing and damping properties in the first spatial direction are determined by the at least one air spring element and in the second spatial direction by the at least one elastomer spring.

To solve this problem, a bearing bush of the initially mentioned type is suggested, which has an essentially rectangular base, wherein the springing and damping properties in the first spatial direction are determined by the least one air spring element and in the second spatial direction are determined by the elastomer spring.

The bearing bush according to the present invention has the advantage that the springing and damping properties in different spatial directions are determined by respective individually adjustable spring elements. The individual spring elements in turn are easily to dimension and to manufacture. Due to the rectangular base of the bearing bush it is particularly easy to arrange an air spring element in the bearing bush, which has a large pump diameter.

Advantageously, the long sides of the housing have at least one air spring element associated with them, and the short sides of the housing have at least one elastomer spring associated with them. This has the advantage that the air spring element can have a large pump surface. In combination with a small volume of the air spring element, excellent damping properties can thus be achieved.

The air spring element can be formed in the first spatial direction between the core and the housing.

The at least one air spring element has preferably a throttle opening connecting a hollow chamber of the air element with the ambient.

Further, the elastomer spring can be formed as a stud arranged between the core and the housing.

It can also be advantageously provided that the bearing bush has two air chambers whose cavities are connected with each other by a channel.

Advantageously, the channel is formed in a channel shell.

Furthermore, the channel can advantageously be integrated in the core. By these measures, the number of individual components can be reduced and assembly of the bearing bush can be further simplified.

In an advantageous embodiment, the bearing bush is subdivided in the horizontal direction and has two half bushes. This is to ensure simple manufacture of the bearing bush.

The half bushes can advantageously have an identical structure. For this reason, the bearing bushes can be manufactured of identical components.

Advantageously, the elastomer bodies of the half bushes can have air pockets which, in the assembled state of the half bushes, form the hollow chambers of the air spring elements. An additional structure for closing the hollow chambers can thus be omitted.

The elastomer bodies of the half bushes, in the assembled state, preferably close the hollow chambers of the half bushes in an air-tight manner. Additional sealing devices can thus be omitted, which makes production simpler and cheaper.

The bearing bush can advantageously have at least one attachment flange. Simple attachment of the bearing bush in a motor vehicle is thus ensured.

Preferably, it can be provided that the elastomer body forms a stop on the attachment flange. The stop simplifies the attachment of the bearing bush.

The core can advantageously have an attachment opening.

Advantageously, it is provided that the elastomer body is inserted between the core and the housing before curing. This ensures secure attachment of the elastomer body on the core and housing.

Other features which are considered as characteristic for the invention are set forth in the appended claims.

Although the invention is illustrated and described herein as embodied in an elastic bearing bush, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective, partially cut-away view of a bearing bush according to a first embodiment of the present invention, wherein a vertical section in a longitudinal and transverse direction is carried out starting from a center of an attachment opening;

FIG. 2 is a horizontal sectional view of the bearing bush of FIG. 1;

FIG. 3 is a section view through the bearing bush taken along the line III-III shown in FIG. 2;

FIG. 4 is a diagrammatic, horizontal sectional view of a channel shell according to a second embodiment of the present invention;

FIG. 5 is a vertical sectional view of the bearing bush according to the second embodiment; and

FIG. 6 is a horizontal sectional view of the bearing bush according to a third embodiment of the present invention.

### DETAILED DESCRIPTION OF THE INVENTION

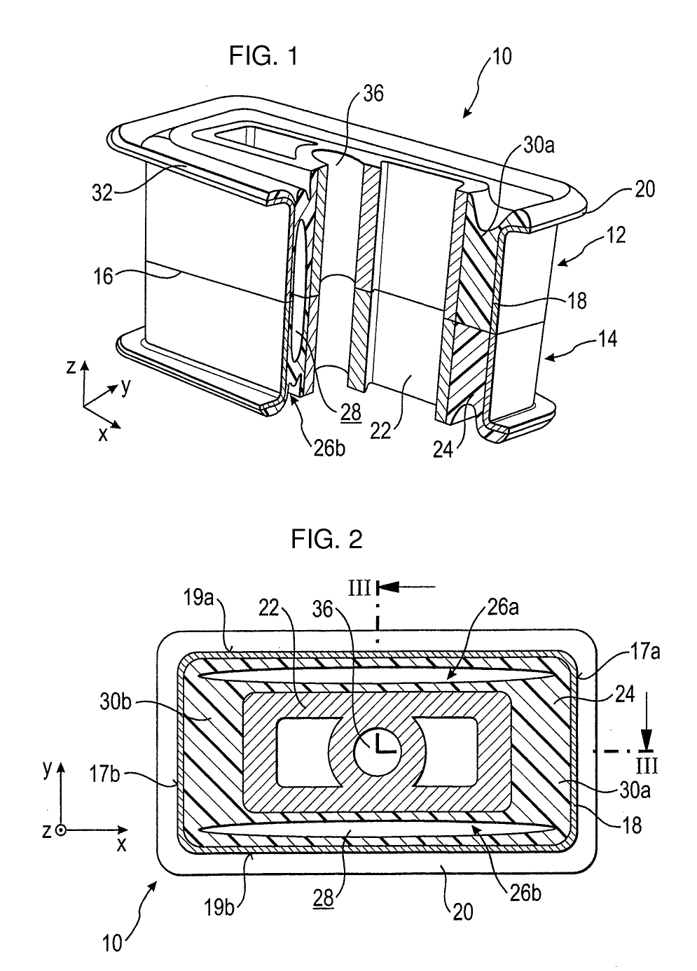

Referring now to the figures of the drawing in detail and first, particularly, to FIG. 1 thereof, there is shown a bearing bush 10 that has a housing 18 having an essentially rectangular basic shape, which is formed with an attachment flange 20. The housing 18 is of metal sheet. A core 22 of metal is arranged in an interior of the housing. Extruded aluminum can be used, for example, to manufacture the core 22. The core 22 is connected with the housing 18 by an elastomer body 24.

The elastomer body 24 is inserted between the core 22 and the housing 18 before curing, so that there is a frictional engagement between the elastomer body 24 and the housing 18, and the core 22.

The bearing bush 10 is composed of two half bushes 12, 14 abutting each other on a contact plane 16 and having an identical structure.

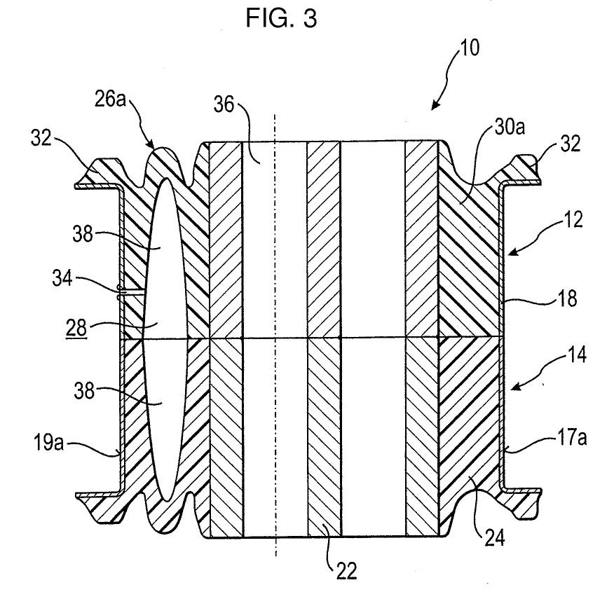

As can be seen, in particular, from FIG. 2, air spring elements 26a, 26b are disposed along longitudinal sides 19a, 19b of housing 18. The air spring elements 26a, 26b each have a hollow chamber 28. The hollow chamber 28 is filled with air in the present embodiment. The hollow chamber 28 of the air spring elements 26a, 26b communicates with the ambient via a throttle channel 34, as can be seen from FIG. 3.

Between end faces 17a, 17b of the core 22 and the housing 18, the elastomer body 24 has an elastomer spring 30 formed as a stud. Further, the elastomer body 24 has stops 32 along the attachment sides of the attachment flanges 20, as can be clearly seen from FIGS. 1 and 3.

A throttle opening 34 is formed in the housing 18, which extends through the elastomer body 24 and the housing 18 up to the outer side wall of the bearing bush 10.

Further, the core 22 has a circular attachment opening 36.

To construct the bearing bush 10, two identical half bushes 12, 14 are assembled at their contact planes 16 and fixed in a holder so that the two half bushes 12, 14 are securely held together. The force pressing the half bushes 12, 14 together closes the elastomer bodies 24 of the half bushes 12, 14 in an airtight manner. The parts of the core 22 are assembled with a slight bias.

As seen in FIG. 3, each half bush 12, 14 has air pockets 38 at its long sides. When the bearing bush 10 is assembled, a hollow chamber 28 is created by two respective air pockets 38 by assembling the elastomer bodies 24 in an airtight manner.

For assembly, the bearing bush 10 with the housing 18 is pressed into an auxiliary frame, for example. A section of the vehicle chassis is then passed through the attachment opening 36 of core 22 and securely connected to it. The core 22 is thus attached on a part of the vehicle.

The bearing bush 10 is aligned in such a way that the air spring elements 26a, 26b are associated with the longitudinal direction x of the vehicle and the elastomer springs 30a, 30b are associated with the transverse direction y of the vehicle.

The bearing bush 10 has different springing and damping properties in each of the x and y spatial directions. In the first spatial direction x, the damping properties are determined by the air spring elements 26a, 26b, which have a damping characteristic which becomes disproportionally stiffer as the vibrating amplitude increases. In the second spatial direction y, elastomer springs 30a, 30b lead to high stiffness in the transverse direction of the vehicle.

The arrangement of the air spring elements 26a, 26b along the longitudinal sides 19a, 19b of the bearing bush 10 causes a large pump cross section of the hollow chamber 28 with an otherwise small hollow chamber volume.

To handle low frequency vibrations and static displacements of the core 22 with respect to the housing 18, the throttle openings 34 are formed in such a way that they enable comparatively slow pressure compensation of the hollow chamber 28 with the ambient atmosphere.

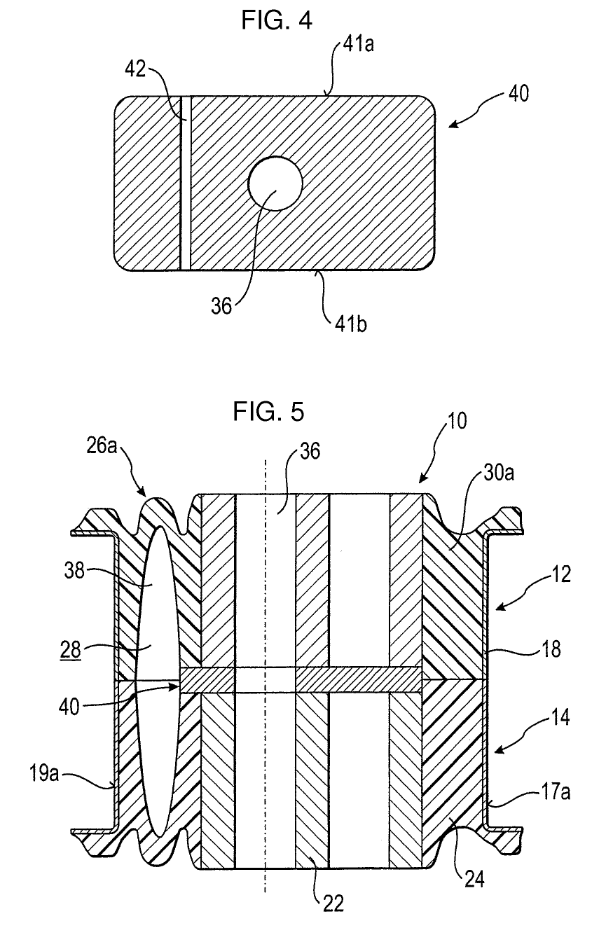

FIG. 5 shows a further embodiment of the bearing bush 10, wherein for its description the above reference numerals will be used for the same or equivalent parts. The bearing bush 10 has a channel shell 40, which is shown in FIG. 4. The channel shell 40 has an attachment opening 36 in alignment with the attachment openings 36 of cores 22. A channel 42 is provided in channel shell 40 and extends from one long side 41a of channel shell 40 to the opposite long side 41b.

The channel shell 40 is arranged between the half bushes 12, 14 so that a communicating channel between the hollow chambers 28 of air spring elements 26a, 26b results through channel 42.

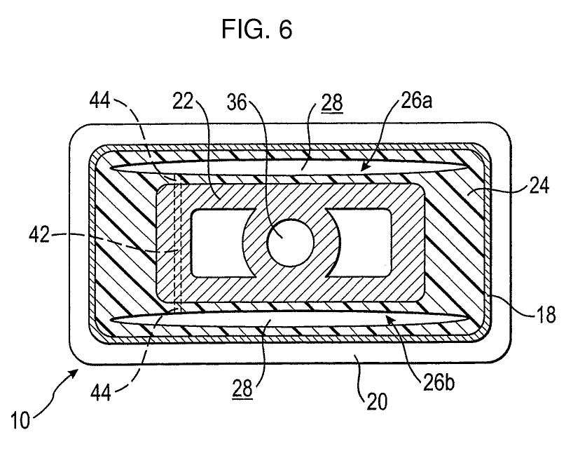

In a third embodiment as shown in FIG. 6, the channel 42 extends through the core 22. For this purpose it is also necessary to provide through openings 44 in the elastomer body 24 to connect the hollow chambers 28 by the channel 42.

The shape of the hollow chambers 28 can be determined by simple changes in the geometry of the elastomer body 24. The damping properties of the air spring elements 26a, 26b can thus be simply and cheaply adjusted.

Moreover, manufacturing the half bushes 12,14 with air pockets 38 is simpler than manufacturing an elastomer spring 24 with a hollow chamber 28 contained therein.

The bearing bush 10 according to the present invention, which is composed of two half bushes 12,14 and which has different springing and damping properties due to air spring elements 26a, 26b and elastomer studs 30 in the spatial directions x and y, has a simple structure and can therefore be cheaply manufactured.

1. An elastic bearing bush, comprising:
a housing;
a core disposed within said housing;
at least one air spring element;
at least one elastomer spring;
an elastomer body connecting said housing to said core;
the bearing bush having a generally rectangular base; and
the bearing bush having different springing and damping properties in a first spatial direction and a second spatial direction, wherein the springing and damping properties in the first spatial direction being determined by said least one air spring element and in the second spatial direction by said at least one elastomer spring.

2. The bearing bush according to claim 1, wherein:
said housing has long sides and said at least one air spring element is associated with said long side; and
said housing has end faces and said at least one elastomer spring is associated with said end faces.

3. The bearing bush according to claim 1, wherein said air spring element is formed in said elastomer body in the first spatial direction between said core and said housing.

4. The bearing bush according to claim 1, wherein:
said air spring element having a hollow chamber formed therein; and
said air spring element has a throttle opening formed therein connecting said hollow chamber of said air spring element with an ambient.

5. The bearing bush according to claim 1, wherein said elastomer spring is formed as a stud disposed between said core and said housing.

6. The bearing bush according to claim 1,
further comprising a channel; and
wherein said air spring element is one of two air spring elements having hollow chambers which are connected via said channel.

7. The bearing bush according to claim 6, wherein said channel is formed by a channel shell.

8. The bearing bush according to claim 6, wherein said channel is integrated in said core.

9. The bearing bush according to claim 1, wherein the bearing bush is subdivided in a horizontal direction and is formed of two half bushes each containing part of said housing, said core, said air spring element, said elastomer spring, and said elastomer body.

10. The bearing bush according to claim 9, wherein said air spring element is one of two air spring elements having hollow air chambers.

11. The bearing bush according to claim 9, wherein said half bushes have an identical structure.

12. The bearing bush according to claim 10, wherein said elastomer body of said half bushes has air pockets formed therein which, in an assembled state of said half bushes, form said air spring elements.

13. The bearing bush according to claim 10, wherein in an assembled state, said elastomer body parts of said half bushes close said hollow chambers of said half bushes in an airtight manner.

14. The bearing bush according to claim 9, wherein said housing has at least one attachment flange.

15. The bearing bush according to claim 14, wherein said elastomer body forms a stop at said attachment flange.

16. The bearing bush according to claim 1, wherein said core has an attachment opening formed therein.

17. The bearing bush according to claim 1, wherein said elastomer body is inserted between said core and said housing before curing.

18. The bearing bush according to claim 1, wherein the bearing bush is configured for use in a chassis of a motor vehicle.
